(19) United States
(12) Patent Application Publication
(10) Pub. No.: US 2011/0173102 A1
(43) Pub. Date: Jul. 14, 2011

(54) Content sensitive point-of-sale system for interactive media

(76) Inventors: Christopher Burns, Ipswich, MA (US); Leland Jon Schwartz, Glen Echo, MD (US)

(21) Appl. No.: 12/657,014

(22) Filed: Jan. 12, 2010

(51) Int. Cl. G06Q 30/00; G06Q 10/00; H04N 7/173; G06F 3/048

(52) U.S. Cl. 705/27.2; 705/14.51; 725/131; 715/781; 705/7.29; 705/26.7

(57) ABSTRACT

A system and method are described for offering items and services for sale that are related to content being displayed in an interactive medium such as the world wide web, public kiosks, hand-held PDAs, tablets, television and other digital devices. The system uses a combination of techniques to select from a catalog of items those which have the greatest relevance to the content being viewed at the time, and it presents those items concurrently in point-of-sale window, allowing the user to purchase the items directly without leaving the content page. Unlike content-sensitive advertising which presents ads even when the relevance of those ads to the content is low, the system alerts the user to the presence of relevant products, presents a point of sale window only if the user requests it, and pays the content publisher a portion of the revenue from sales initiated on his content page.

### CROSS REFERENCE

None

### FEDERALLY SPONSORED RESEARCH

None

### SEQUENCE LISTING OR PROGRAM

None

### BACKGROUND OF THE INVENTION

1. Field of the Invention

The present invention relates to the point-of-sale presentation of items related to content being displayed in an interactive medium such as the world wide web, PDAs, public kiosks, television and other digital devices. The system uses a combination of techniques to select from a catalog of items those which have the greatest relevance to the content being viewed at the time, and it presents those items for sale concurrently in a subordinate window, allowing the user to purchase the items directly without leaving the content page. Unlike advertising in which the seller pays the content publisher a fee to present his marketing message to the audience regardless of the outcome, this invention proposes a new economic model in which the seller sells the item directly on the site, and shares the revenue with the content publisher.

2. Prior Art

Most of the $300 billion spent on advertising in the US each year is wasted. It doesn't efficiently reach the people who are interested in the product, or doesn't reach them at a time when they are ready to purchase. Today the new electronic publishers, like print and broadcast media before them, compete to reduce this waste by offering their audience in increasingly specific segments, trying to deliver the message to better qualified users at a moment when they have indicated an interest. And still sellers lack the tools and information necessary to guide their marketing activities. This problem has gained new attention in the last decade as electronic publishers develop technology to present advertising messages only to those users whose demographics, interest profiles, purchasing history, location, and business circumstances qualify them as high potential buyers.

### A. Matching Ads to the User's Profile

The simplest technologies have focused on matching advertisements to online users based on the profile of the individual user.

U.S. Pat. No. 5,933,811 (1999—Angles) selects matching advertisements from a catalog of possible ads based on the user's profile as inferred from information stored in the user's system (“cookie”) or in the user's record stored in the publisher's e-commerce database. A user interested in skiing sees ads for skis. A user in Chicago sees ads for Chicago area stores and services.

U.S. Patent #20070162456 (2007—Agassi et al) selects advertisements from a catalog of ads based on the user's business context, taking into account the user's business role, the activity the user is engaged in, and the nature of the business, all inferred from information previously provided by the user or apparent from the current transaction.

US Patent #20080256462 (2008—Chao/Yahoo) similarly selects and presents an ad based on the user “scenario” as inferred from information stored on the user's own system (the “cookie”). The technology considers the user's age, gender, and profession as well as the user's location, inferred from the IP address.

U.S. Patent #20080140524 (2008—Shubhasheesh/Yahoo) describes technology in which the ad is not selected from a catalog of existing ads, but dynamically assembled from information components—product name, description, price, marketing message—all stored in a database. Not only is the ad selected for a very specific audience, but the ad itself is created on the fly to most efficiently address the marketing opportunity.

U.S. Patent #20080243526 (2008—Nance/Google) selects and presents advertisements based on a more detailed profile of the user, as presented in individual pages on social networks.

### B. Matching Ads to Users Based on Location and Other Factors

More complex matching technologies and tools have also been developed.

U.S. Pat. No. 7,313,622 (2007—Lee/X+1 Solutions) manages a catalog of merchandiser's product information and presents “matching” information to users in different formats, based on stated user interest, user's hardware, user's current location and other factors, allowing the merchandiser to keep better track of the many different ads and formats that now exist for a single product. The technology determines the profile of the user and presents the most appropriate version of the ad.

U.S. Pat. No. 7,376,714 (2008—Gerkin) selects and presents an advertisement based on the user's IP address. The intent is to make local advertising more efficient by showing it only to users who live within the advertiser's radius of interest.

U.S. Patent #20080086368 (2008—Bauman/Google) also selects and presents advertisements based on location of user, but in this case the technology shows how the advertisers can be presented on a map of the user's market area, along with targeted advertising.

U.S. patent #20080052151 (2008—Xie/Microsoft) also selects and presents advertisements based on the location of the user, also in a map format, but in this case the user can move to different segments of the map and see other advertisers.

### C. Selects Most Relevant Ads Based on Multiple User Characteristics

U.S. Pat. No. 6,009,410 (1999—LeMole/AT&T) broadens the scope of the matching activity by showing how ads from multiple merchandisers can exist together on a single advertising server, and be presented by a third party facilitator to users whose demographic information and previous purchases match the target market.

U.S. Patent #20050149532 (2005—Hubbard/United Devices) selects and presents advertisements based on attributes of the user's viewing device.

U.S. Patent #20090043657 (2009—Swift/Palm) shows how advertisements can be selected for presentation based on the user's mobile caller ID, which in turn can be used to determine other user characteristics including demographics, interest profile and past activity.

### D. Selects Most Relevant Ads Based on User's Transaction Activity and History

The purpose of these matching technologies is to present each user with advertising that has the greatest relevance. Thus the advertiser would not present ads to users with a low propensity to buy, and users would not be presented with ads in which they have no interest. One of the most reliable indicators of user interest is the user's own transaction history, and several technologies have been developed to select from a catalog of ads those which are most like products and services the user has purchased in the past.

U.S. Pat. No. 6,757,661 (2004—Blaser/NetZero) selects from a catalog of ads the one that is judged “most relevant” to the user based on personal profile, geographic location, network usage, and demographic information such as age, gender, occupation, marital status. Past activity is classified and tagged. Ads are similarly tagged according to the activity they most relate to, and then the ad tags and activity tags are matched. If the current activity identifier matches one or more of the advertisement identifiers, the system causes that ad to be presented.

U.S. Patent #20050204381 (2005—Ludvig/Microsoft) describes technology to provide cable and broadcast television systems with the similar ability to present some of the ads to some of the subscribers. For each subscriber, a purchasing history and interest profile is compiled and characterized. Advertisements are similarly characterized. Advertisements intended for a selected audience are then broadcast over a parallel channel, and the user's client device switches to that channel if the character of the alternative ad matches the user's purchasing history and interest. Otherwise the user receives the “default” ad intended for a general audience.

U.S. Patent #20080103887 (2008—Oldham/Google) selects and presents advertisements based on user transaction history. The technology selects multiple ads, ranked in descending order, that describe products and services similar to what the user has purchased in the past.

U.S. Patent #20080270398 (2008—Landau) recommends additional products based on similarity to product being considered. The technology calculates the affinity between products currently being considered on screen and other products in a catalog, and makes a recommendation.

### E. Selects Product Advertising Based on Content Being Viewed

The technologies that look at user location and demographics, purchasing history, device attributes, and stated interests rely on a process of categorizing the user, categorizing the ads and then calculating the similarity of the two. The same approach can be taken to matching advertisements to the content being viewed.

U.S. Pat. No. 6,654,725 (2003—Langheinrich/NEC) selects and presents product advertising based on search results or content being viewed at the time. When the user opens a page of content or search results, the technology simultaneously examines the content of the page being viewed, selects an ad from its catalog that “best fits” the topic, and then places that ad on the same page in a space the publisher has blocked out for such ads.

U.S. Pat. No. 6,804,659 (2004—Graham/Ricoh) describes a similar technology which searches the content being viewed and infers the subject of the content by natural language concept tagging. The advertiser also determines which concepts are most relevant to his product or service, and the technology tries to match the subject of the content with the nature of the product.

U.S. Pat. No. 7,124,093 (2006—Graham/Ricoh) expands on the earlier technology by permitting a broader set of matches between content viewed and ads in the catalog, placing the selected ad on the page.

U.S. Pat. No. 7,257,589 (2007—Hull/Ricoh) describes still another expansion of the concept tagging technology. In this invention the ad “server” selects advertising based on match between concept tags developed for the document and preselected tags associated with the advertisement. The technology calculates “relevance” based on the two sets of tags and selects the ad that “best fits” the content being viewed.

U.S. Patent #20080270359 (2008—Madhavan/Yahoo) focuses on the content presented by search engines, and describes how the system can perform a semantic analysis of that content, extract the concepts which seem to be involved, compare those concepts to the tags assigned to ads in the catalog and then present the ads that seem to be the best fit.

U.S. Patent #20080027798 (2008—Ramamurthi) describes an expanded concept tagging technology which considers not only the content being viewed but also secondary information such as keywords on the page and the content of pages that may be linked to the content being viewed. The technology then selects from its catalog of ads, the one whose concept tags “best fit” the content being viewed.

### F. Deficiencies

As important as it is to find ways to bring more relevant advertising messages to online users, the technologies developed to date share a number of serious flaws.

The technology of concept tagging has proven too abstract. Natural language analysis characterizes a news story, a search result or a content page with a few topic words that are rarely specific enough to guide product recommendations. Using concept tags to characterize products and services in a catalog of ads is a similarly imprecise way to describe products that differ from each other often only in small but important details. And matching one set of concept tags to another set of concept tags compounds the potential error. The result has been that advertisements chosen by concept tagging systems are often not relevant to the content being viewed, and online users quickly learn to discount the value of the recommendations. The ads are ignored.

The web site publisher dedicates space to the “best” ad or the “best few ads” chosen by the matching algorithms, even when the relevance score is low. Sometimes the match is good, often it is not, but the advertiser is charged the same rate in every case. With recommendations of uneven value, the advertising loses its authority and the seller's advertising budget is wasted.

Even relevant internet advertising draws the user away from the publisher's page, rather than building loyalty to the site. Text only ads, in particular, are links away from the content, which is directly contrary to the sustained user interest the web publisher is trying to encourage. When the advertising works, the publisher loses.

The most serious deficiency exhibited by technologies that match advertising to content is that advertising itself is no longer the useful information tool it was in print or broadcasting. In the shortened purchase cycle that now prevails on the Internet, buyers prefer to get their product information from competing retail sites, from independent reviewers, and from other consumers. And they are able to do so easily. Recent studies suggest that the traditional model of research, judgment, purchase does not apply to low-priced items like books, music, movies, packaged goods, gadgets, and accessories. Advertising has far less value on the internet than in any previous medium. What users want instead is a direct link to the point of sale.

### SUMMARY OF THE INVENTION

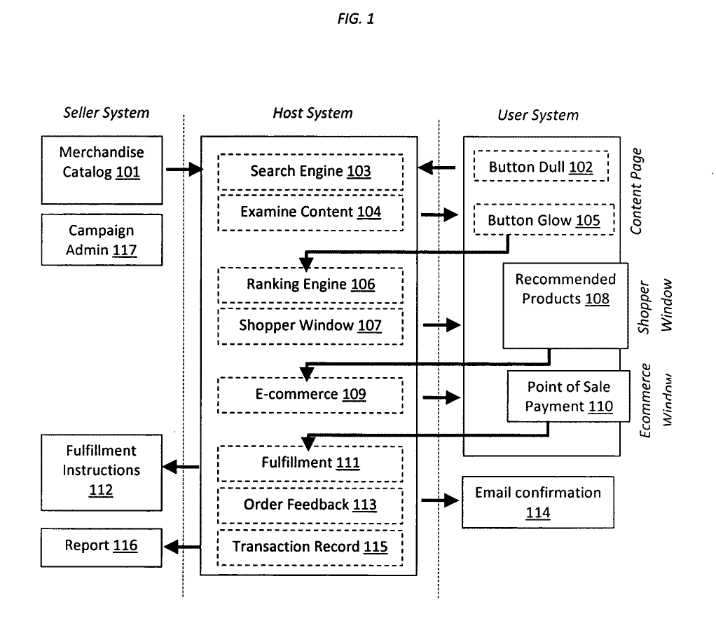

The invention described here examines the content being viewed by a user on an interactive electronic device such as web browser, tablet, PDA, public kiosk, or video device. It selects from its catalog those products that are relevant and presents them in a quick shopping window where they can be purchased directly (FIG. 1). The system consists of five major components:

Merchandise catalog (101). Products are entered into the catalog by participating sellers. Each product is associated with a brief description, an image, a price, and other data necessary to complete an e-commerce transaction. The product is also associated with one or more Boolean search strings designed to identify that product when it is mentioned on a content page.

Alert button (102). Participating electronic publishers incorporate a button on each content page. When the page is opened, the button triggers a parallel search of the content by the host system (103) (104), and if any of the products in the catalog are found, the button graphic is changed to one depicting the button in a “glowing” state (105) to indicate to the user that the shopping window has some recommendations. The items found are ranked (106) and filtered according to the user's pre-stated interests (107).

Shopping window (108). When the user clicks on the glowing button, a popup window appears listing the products that have been identified, giving an image, a brief description and the price in each case. The user can purchase one or more of those products or search more deeply in the shopping window. The user can also invoke alternative ranking rules that reflect a personal preference.

E-commerce Window (109). If the user clicks on an item in the shopping window, the system opens an e-commerce window where the details of the purchase are gathered and confirmed (110). The user agrees to the purchase, or cancels it and returns to the content page.

Fulfillment (111). Once the user has agreed to the purchase, the shopping window closes. The reader is returned to the content page, and the system sends shipping instructions to its fulfillment partner (112). The system gets order feedback from the fulfillment partner (113), and sends the user an email message confirming the order (114). Then the system completes a record of the transaction (115) and sends the product seller a report (116).

### Key Advantages:

Matching products to content using one-way Boolean search is more accurate. In the invention described here, matching is based not on concept tagging but on a strict Boolean search of the content page using one or more search strings such as title, author, marketing phrase, buzzword, or even the name of a competing product. Boolean search strings are easily understood and have a long record of successful utilization.

Only qualified recommendations appear. The system alerts the user only if there are product recommendations that pass a personal threshold of relevance. Preferences stored in the user's cookie can further limit recommendations to a class of products, a format, a price range and a geography so the user is presented only with qualified recommendations. In any event the alert button occupies only a small portion of the screen space.

Point of sale. The system does not deliver advertising or link the user to another site. It takes the user directly to the point of sale in a concurrent and subordinate window. For low cost items and impulse purchases, this is more convenient than trying to remember to purchase the product later, or going to an e-commerce site and then finding one's way back to the content. Once the sale is complete, the shopping window is closed and the user is back on the content page. The system does not draw the user away from the original content or from the publisher's site.

Revenue sharing. In the nominal embodiment, the web publisher does not receive advertising revenue based on the size of his audience, the space taken by the ad or the number of times users click away from the site. Instead, the publisher receives a portion of the purchase price of all products purchased by his viewers while viewing his pages. Compensation is thus more reasonably related to value delivered, without competing with the publisher's own desire for increased viewer loyalty and pages viewed. The seller only pays the marketing cost when a sale occurs.

Marketing flexibility. The seller is able to easily modify the search string associated with his product to refine and narrow the matching algorithm, change it to associate his product with breaking news, or even target the mention of competing products. For each product, each day, the online campaign management report tells the seller how many times the item was found mentioned on content pages, how many times it was presented to users, how many times it was selected and purchased (“sell-thru”), and how many times a competing product was purchased instead. This information gives marketers a much more intimate and timely view of how their product is selling, along with the tools necessary to manage and modify the campaign.

### DRAWINGS—REFERENCE NUMERALS

101—Merchandise Catalog
102—Button Dull
103—Search Engine
104—Examine Content
105—Button Glow
106—Ranking Engine
107—Shopping Window
108—Recommended Products
109—E-commerce
110—Point of Sale Payment
111—Fulfillment
112—Fulfillment Instructions
113—Order Feedback
114—Email Confirmation
115—Transaction Record
116—Report
201—Alert Button
301—Open Content Page
302—Button Calls Status
303—Examine Content
304—Blinking Button
305—No Items
306—Items Found
307—Search Catalog
308—Shopping Window
309—Open Shopping Window
310—e-commerce Window
311—e-commerce Process
312—Confirmation
313—Fulfillment Process
314—Seller
315—Email
401—Button Call
402—Retrieve User Preferences
403—Open Parallel Content Page
404—Run Compound Search
405—Database of Item Search Strings
406—Score Items for Relevance
407—Record Results of Content Exam
408—Relevant Items?
409—Open Shopping Window?
410—Rank Selected Items
411—Open Shopping Window
412—Buy/Hold Item
501—Product Class Selector
502—Ranking System Selector
503—Apply Personal Preferences
504—Item Description
505—Buy/Hold Buttons
506—See More Recommendations
507—Search Catalog
701—Sell-thru
801—Matched items
802—Average Position on List
803—Sell-thru

### BRIEF DESCRIPTION OF THE DRAWINGS

FIG. 1 is a simplified block diagram of the overall system, showing the seller's activities and components, the user's activities and components, and the system host activities and components.

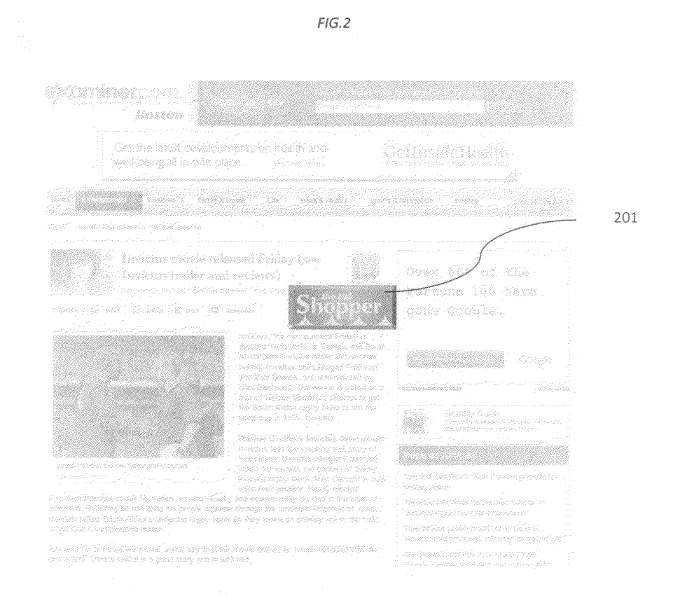

FIG. 2 is an illustration of the user alerting mechanism, the “button”, as it may appear in a web embodiment of this system. In other embodiments of the system for television, PDA's, public kiosks and other media, the alerting mechanism may take a different form.

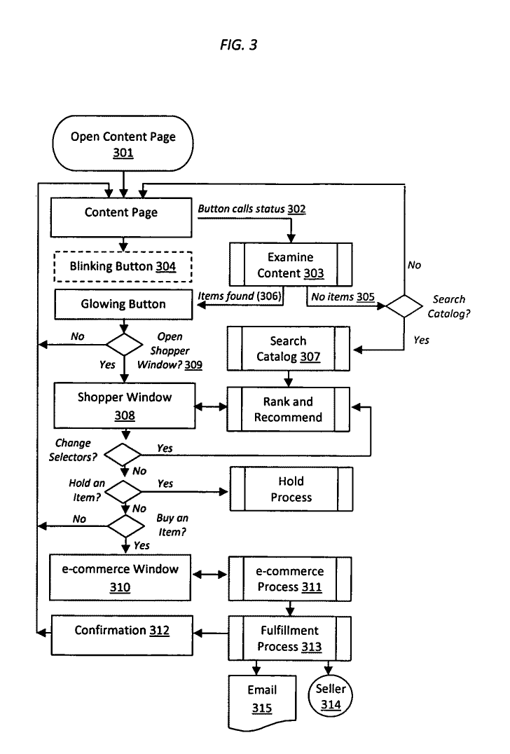

FIG. 3 is an overall flow chart showing the steps taken by the user from the time a content page is opened to the time a confirmation of the sale is received.

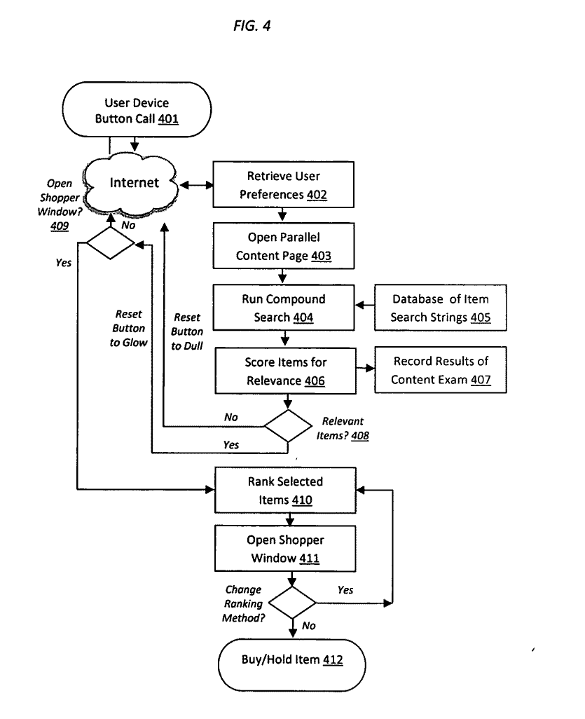

FIG. 4 is a flow chart of the examine content process

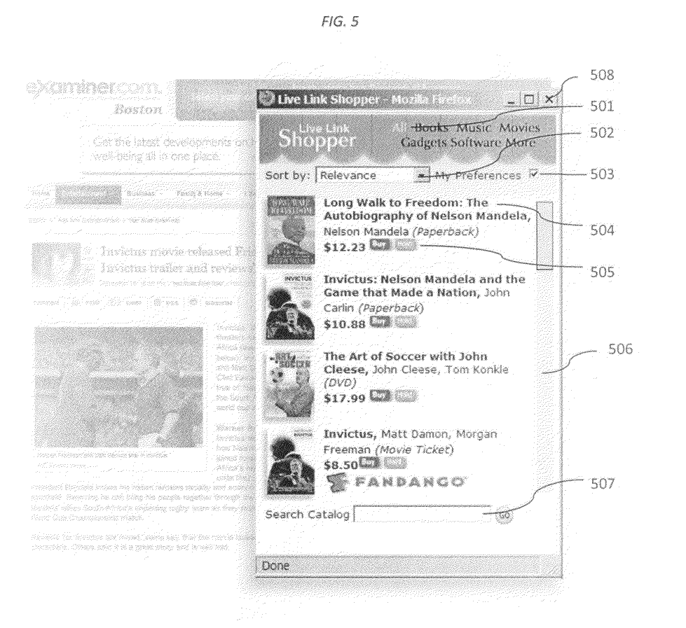

FIG. 5 is an illustration of the shopping window as it may appear in a web embodiment of the system.

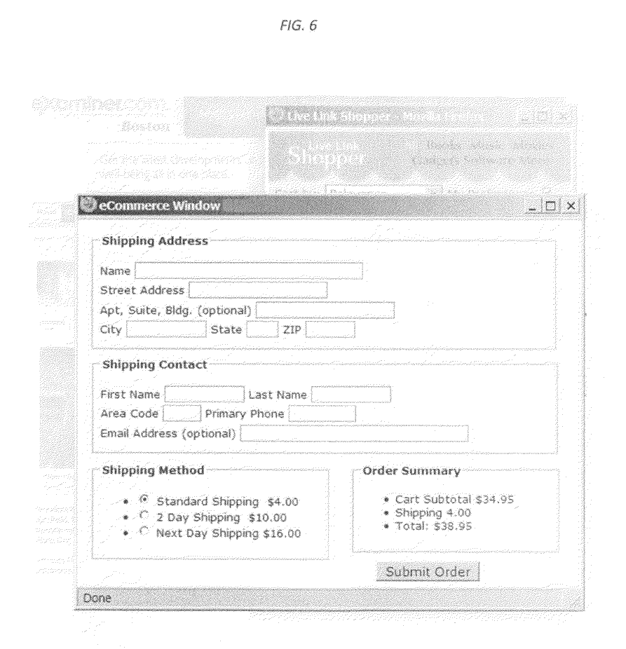

FIG. 6 is an illustration of the e-commerce window as it may appear in a web embodiment of the system.

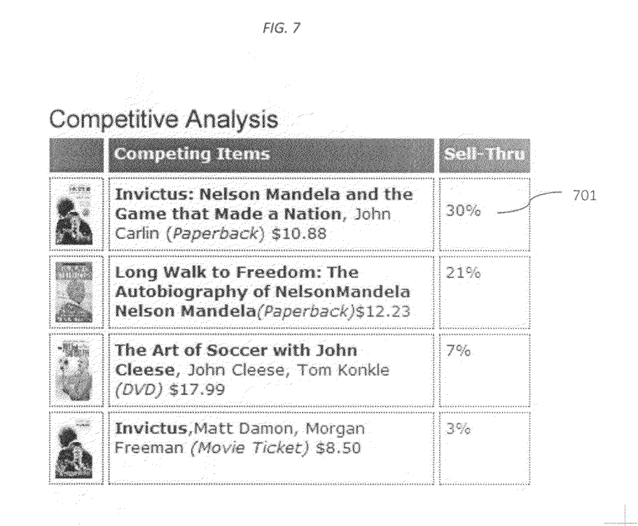

FIG. 7 is an illustration of the competitive analysis panel as it may appear in a web embodiment of the system.

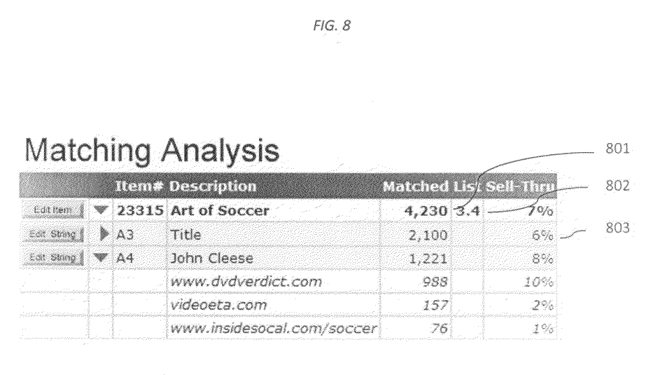

FIG. 8 is an illustration of the matching analysis panel as it may appear in a web embodiment of the system.

### DETAILED DESCRIPTION OF THE INVENTION

1. Creating the product catalog. In the nominal embodiment, the seller of products and services uses the system's online catalog management module to create a seller account and enter one or more items into the catalog. Information required for each item includes item identifier, name, image, description, price, product class (e.g. book, movie, music, software, electronics, tickets, or other), format (e.g. hardback, paperback, digital), language, seller state/country, shipping weight, ship from location, fulfillment partner, SKU, user rating, editor rating, and units sold in the shopping system last month (updated by the system). In the nominal embodiment, the system includes in its catalog only those products placed there by affiliated sellers. Those are the only products it searches for in the user content, and the only products it will recommend.

Also associated with each product in the catalog are one or more Boolean search strings which will be used by the system to match the product to the content being viewed. Each search string incorporates the normal Boolean operators including this and that, this or that, this exact phrase, this but not that, this within n words of that. Strings will be designed by the seller to identify mentions of the title or product name; the author, artist or subject person; or a subject, term or phrase often used in connection with the product (e.g. “PDA”, “jump drive”, “low-carb diet”). The seller may also construct a search string to identify a competing item, or the description of a recent event so that the item will be recommended whenever that competitor or event appears in the content. The goal is to give the reader a convenient purchase opportunity by identifying reviews, blog posts, news articles and other content that may describe or be relevant to the product being marketed.

Using the catalog management module, the seller can modify the search strings at any time in order to adjust the matching algorithm to current events, product announcements or changes in marketing strategy. The system allows search strings to be set up in test mode to see how efficiently they identify opportunities. In this case the match is made and recorded, but the product is not presented in the shopping window. For each search string, the system reports the number of times the string finds a match, including the date/time, URL, and content zone of each match.

2. Installing the alert button. In the nominal embodiment, any web site, video publisher, public kiosk system or provider of a personal digital assistant (PDA) device such as a wireless phone, portable media player, tablet, or wearable computer component can participate in the shopper system by incorporating the button on its content pages (FIG. 2). The process of incorporating a button requires the participant to create an account with the system by which revenues will ultimately be distributed. The software unique to that participant and that page is created by the host system, then the button graphic and enabling HTML code is made available for download. The alert button (201) is a predetermined size, but it can be placed anywhere on the content page. The button will cause a search only of the content page it is located on. In a nominal embodiment, the web site or content publisher will make the button part of its standard content page template.

3. Button functions (FIG. 3). When the user opens a content page (301) containing the button, the HTML code associated with the button sends the host system the URL of the page on which is it located, along with the current user preferences and a call for a new “status” (302). This invokes the content examination process (303) described below. While the examination is occurring, the button is in a blinking state (304). When the search has been completed, the button returns to a “dull” state if no matching products are found (305), or to a “glow” state if any match has been made between the content page and one or more of the products in the catalog (306). In other embodiments, presented on other devices, the alert button may take a different form.

If the user clicks the button while it is in a “dull” state, the shopping window will open but no recommendations will be made. The user may then search the entire catalog using a standard Boolean search construction (307). If the user clicks the button when it is in a “glow” state, the shopping window process will be invoked (308), as described below.

4. User preferences. If the button has not been clicked by the user before, or if the user information, nominally embodied in the cookie, has been erased, opening the page will invoke the user preferences routine, and invite the user to enter information that will guide the search, shopping, and fulfillment processes. The preferences may include, but are not limited to:

Turn alert button on or off

Include/do not include certain product classes (book, movie, music, software)

Include/do not include certain product formats (paperback, hardcover, Blu-Ray, theater)

Include/do not include (languages)

Device attributes (web browser, PDA, kiosk, video receiver)

Display language (languages)

Email address

Rank recommendations using

Relevance narrow (item mentioned in headline)

Relevance broad (item mentioned anywhere in content)

User rating

Editor rating

Sales

Demographic information (optional) including age, gender, income and ZIP code.

5. The content examination (FIG. 4). When the content page is opened, the alert button sends its location to the host system and calls for a new status (401), which in turn begins the content examination process by which products in the catalog are matched to reviews, blog entries and news stories on the content page.

The first step is to retrieve the content page location and user preferences from the client device (402). The host system then opens a parallel copy of the content page (403) and runs a search on the page (404) using all the search strings associated with items active in the catalog at that moment (405). The search focuses on the four zones of the content page, one at a time, and identifies the items in the catalog that are relevant to the content being viewed. These selected items are then scored (406) according to their location in the content, (title=4, top paragraphs=3, elsewhere in the content=2, keywords and metadata=1). This allows the system to recognize that the mention of a product name or key phrase in the headline is a more significant sign of relevance than the mention of the product later in the story.

The items are then examined in the context of the user preferences, and the system deselects those in which the user has indicated no interest. These exclusions may be because of product class or format, because of the user's geographic location, or because of other factors including age, gender, income and device characteristics. The results of this examination are recorded for later analysis by sellers (407).

If there are no remaining items selected at this point (408), the system returns the call to the alert button on the client screen, resetting it to a dull state. No items in the catalog have been found relevant to the content being viewed. If some items are found to be relevant, the system sets the button to a glow state on the screen of the web page, the PDA screen, the public kiosk or the screen of the video monitor. The user now has the option of clicking on the button to open the shopping window, or ignoring the button (409). If the user chooses to open the shopping window, the system ranks the items according to whichever ranking scheme the user has chosen, such as by sales, by popularity, by third party critical rating or by relevance to the content (410). Then the shopping window is opened (411) and the user has the opportunity to buy an item or hold it for later consideration (412).

6. The shopping window (FIG. 5). In the nominal embodiment, the shopping window consists of 8 elements:

a. Product class selector (501): A simple mechanism is offered by which the user can narrow the results displayed to one of the several classes of products, such as books, music, movies, tickets, software, electronics and more. In an expanded embodiment, the system may allow the user to further narrow the list of recommendations by sub-class and format within product class. Thus the user may focus on non-fiction paperbacks, top of the chart CD's, Windows software or discount tickets to sports events in the region. These two selectors help the user focus quickly and simply on some product recommendations and not others. By changing these settings the user can browse through classes of recommendations in a small window.

b. Ranking method (502): A third selector allows the user to select the way in which the recommendations are ranked, including by sales, by popularity, by third party critical rating or by relevance to the content.

c. User preferences (503): The user may choose to have the recommendations filtered by format, language and other preferences stored in the device memory (the “cookie”).

d. Items (504): The main portion of the shopping window is a simple list of the items that might be of interest to a user reading this content page. They are presented according to the ranking method selected, and the first few items are immediately visible. The following items of information are presented for each item: an image, title, brief description, format, price, and user ranking. If the user allows the pointing device to hover over any item, a larger description of the item is presented. The up and down arrow keys scroll the window up and down. The left and right arrow keys shift to a different ranking method.

e. Buy and hold (505): Beside each item are two buttons: the “buy” button adds the item to the user's shopping cart and opens an e-commerce page, described below. The “hold” button adds the item to a queue of saved items to be considered later.

f. More recommendations: By scrolling the window down (506), the user can see all the recommended items, up to a limit of 20.

g. Search catalog (507): Also part of the shopping window is a search box, allowing the user to search the catalog at any time using conventional Boolean search terms. The results of the search are presented in the shopping window in place of the recommendations, and all the product class, format and ranking selectors apply as before. At any time the user may return to the recommended items.

h. Close window (508): If no action is desired, the user may close the shopping window and return to reading the content page.

7. E-commerce window (FIG. 6). When the user clicks the buy button associated with any item, the e-commerce window opens and the user is prompted to add the item to his shopping cart. The user may then complete the transaction or return to the shopping window (FIG. 3, 310). In the nominal embodiment, the system handles the e-commerce transaction directly with the customer (311), collecting shipping address and options, billing address and payment method, and confirming the transaction. The funds are collected by the system and remitted to the fulfillment partner or partners, minus the shopping system fee. Alternatively, the e-commerce transaction is handled by the fulfillment partner and the shopping system fee is remitted back to the system. All customer service, order tracking, returns and adjustments are handled by the fulfillment partners who are established online retailers specializing in a particular class of products. When the transaction is complete, the user receives a confirmation message (312). The user may then choose to buy another item or close the shopping window and return to the content page.

8. Fulfillment (313). Once the transaction is complete, the system sends the order to the fulfillment partner responsible for that item (314). The fulfillment partner handles shipping, customer service and inventory control. In return, the system receives a confirmation code, order number and tracking data.

9. Confirmation (315). When the transaction with the fulfillment partner is complete, the system sends an email to the user confirming the purchase and providing the details of the order, the contact information for the fulfillment partner and the tracking information.

10. Putting an item on hold. If the user chooses to put an item on hold instead of purchasing it right away, the system responds with a brief message acknowledging the action. An email is then sent to the user's address, and the user has an opportunity to go directly to the e-commerce page later by clicking on a button that is part of the email message.

11. Report. For each item matched to a content page, the system sends the seller an electronic report on every user session in which the seller's product was matched to the content, including the date/time, URL, content zone in which the match was found, search string used in the match and the number of hits. This allows the seller to track mentions of the product in real time on any of the participating browsers, PDAs, public kiosks or other information display devices. It further allows the seller to identify the extent of coverage his item is receiving, and to gain some real time insight into whether it is positive or negative.

The system also updates the seller's dashboard, an online screen showing the number of times the item was viewed and sold (FIG. 7). This allows the seller to measure the strength of each product in real time against named competitors. In the nominal embodiment, one panel on the seller dashboard shows the seller's product compared to the top five products which were matched by the system to the same content, ranking them in order of sales (701). In this way the seller can see the number of times the item was sold as a percentage of the times it was presented to a user in the shopping window, and see how well the competing products did as well.

The system also posts a report to the seller dashboard providing an analysis of the matching activity. The analysis (FIG. 8) shows for each item, and for each search string associated with that item, how many times the item was matched to a content page being viewed by a user (801). It calculates the average position (802) of the item on the shopping window list, an index of how the ranking system treated this item. A list value of 1 indicates that the system always found the item to be the most relevant, most popular, best selling and best reviewed item among all the items that were matched to that content. A list value of 3.4, on the other hand, indicates that on average the system offered the item as the 3^{rd} or 4^{th} recommendation. Finally the system reports the sell-thru for the item (803), and for each search string, giving an indication of how efficient the marketing message is and how attractive the product. For each search string, the system reports where the product was most frequently mentioned and sold, including the web site, geographic region, time of day and other relevant information.

Although specific embodiments of the invention have been described, various modifications, alternative constructions, and equivalents are also encompassed within the scope of the invention. The described invention is not restricted to operation within certain specific information processing environments, but is free to operate within a plurality of media systems and devices. Additionally, although the present invention has been described using a particular series of transactions and steps, it should be apparent to those skilled in the art that the scope of the present invention is not limited to the described series of transactions and steps. Further, while the present invention has been described using a particular combination of hardware and software, it should be recognized that other combinations of hardware and software are also within the scope of the present invention. The present invention may be implemented only in hardware, or only in software, or using combinations thereof.

The specifications and drawings are, accordingly, to be regarded in an illustrative rather than a restrictive sense. It will, however, be evident that additions, subtractions, deletions and other modifications and changes may be made without departing from the broader spirit and scope of the invention-as set forth in the claims.

The invention's unique ability to combine point-of-sale presentation, content and an indication of the reader's interest provides a window into the marketplace that has not been available in any marketing system before. For the first time it is possible to track sales of books, music, movies and many other item classes in response to reviews, news stories and mentions. The seller pays only when the sale is made, and can tell exactly how efficiently his marketing message is in reaching the intended audience. The waste of advertising dollars is reduced, and a new, more cost-effective system for marketing has taken its place.

What is claimed is:

1. A system and method for automatically detecting and presenting for sale on an interactive electronic device products and services relevant to the content being viewed on said device at the time, comprising the steps of:
(a) automatically identifying products and services that are relevant to said content,
(b) selecting from said relevant products and services those which match at least one of a plurality of user characteristics including but not limited to current interests, preferences, demographics, location, and device attributes,
(c) ranking said selected products and services according to at least one of a plurality of ranking methods including but not limited to sales, popularity, third party critical rating, price, date of market introduction and relevance to said content,
(d) presenting said ranked products and services in a concurrent shopping window, and
(e) enabling the user to complete the purchase substantially within said shopping window and its associated transaction windows,
whereby the user is automatically informed of products and services relevant to said content being viewed, and is presented with an opportunity to purchase said products and services directly without closing or leaving said content page.

2. The system of claim 1 wherein said device is a desktop, notebook, tablet, hand-held or wearable computer or communications device in which said content page and said shopping windows are presented in a manner familiar to users of said devices.

3. The system of claim 1 wherein the manner of alerting said user to the availability of said relevant products and services is a visible or audible signal such as an interactive button or an icon familiar to users of said devices.

4. The system of claim 1 wherein said device is an interactive television receiver or video player in which said relevant products and services are inferred from an examination of the transcript, closed caption text, or other non-video data embedded in the video signal.

5. The system of claim 1 in which said device is connected to an independent system host over the internet or a wireless network.

6. The method of claim 1 wherein said inference of relevant products and services is accomplished by searching said content for a Boolean string of words or phrases determined by the seller of said products and services to be closely associated with the nature, subject or purpose of said products and services.

7. The method of claim 1 wherein said inference of relevant products and services by said Boolean search technology is used to identify and present to said user other information including but not limited to reviews, recommendations and advertising.

8. The method of claim 1 wherein said selection of relevant products and services is accomplished by comparing a plurality of said product and service characteristics, as determined by the seller of said products and services, to a plurality of said user characteristics, as determined by said user, including but not limited to current interests, product and service preferences, user age, gender, income, education level, language, geographic location, time of day, current weather and attributes of said interactive electronic devices being employed to view said content.

9. The method of claim 1 wherein said shopping window or its associated transaction windows permit said user to purchase said products and services directly without being linked or transferred to another page, site, system or service provider.

10. The method of claim 1 wherein said shopping window is presented while said content is still accessible to said user with a single click or gesture.

11. The method of claim 1 wherein the sale, delivery or fulfillment of said products and services is accomplished by a merchandiser, reseller or fulfillment partner not the publisher of said content.

12. The method of claim 1 wherein said publisher of said content receives a portion of the price of all said products and services purchased by said user while viewing said content.

13. The method of claim 1 wherein the system records and reports transaction details in order to assist said seller in the marketing of said products and services.
